(19) United States
(12) Patent Application Publication
(10) Pub. No.: US 2016/0082608 A1
(43) Pub. Date: Mar. 24, 2016

(54) Nose hair trimmer

(71) Applicant: Chin-Hung LI, Kaohsiung City (TW)

(72) Inventor: Chin-Hung LI, Kaohsiung City (TW)

(21) Appl. No.: 14/850,971

(22) Filed: Sep. 11, 2015

(30) Foreign Application Priority Data
Sep. 18, 2014 (TW) 103216777

(51) Int. Cl. B26B 19/14; B26B 19/38

(52) U.S. Cl. CPC B26B 19/148; B26B 19/38

(57) ABSTRACT

A nose hair trimmer contains: an accommodating cylinder and a coupling column. The coupling column is inserted into a through hole of the accommodating cylinder, such that the coupling column is coaxial to the accommodating cylinder, and a plurality of first cutters on a top of the accommodating cylinder correspond to plural second cutters on a top of the coupling column, wherein between any two adjacent first cutters is defined a first slot, and between any two second cutters is defined a second slot, such that the coupling column rotates relative to the accommodating cylinder. Preferably, each first cutter of the accommodating cylinder has a tooth portion formed thereon.

### FIELD OF THE INVENTION

The present invention relates to a nose hair trimmer which trims nose hairs and eliminates cut nose hair easily.

### BACKGROUND OF THE INVENTION

A conventional nose hair trimmer contains an accommodating cylinder and a coupling column, wherein the accommodating cylinder has plural first cutters, and the coupling column has plural second cutters, such that the coupling column rotates relative to the accommodating cylinder to cut nose hairs.

However, after the nose hair trimmer is inserted into a nose, it presses the nose hairs to a wall of the nose, and because a diameter of the nose is larger than those of the plural first and second cutters, the nose hairs cannot insert into slots among the plural first and second cutters, thus cutting the nose hair difficultly.

Furthermore, the nose hair trimmer cannot operate after power of a battery consumes completely.

The present invention has arisen to mitigate and/or obviate the afore-described disadvantages.

### SUMMARY OF THE INVENTION

The primary objective of the present invention is to provide nose hair trimmer in which the fitting sleeve is grasped by one hand, and the base is rotated by the other hand to drive a rotation of the coupling column with respect to the accommodating cylinder, such that the plural second cutters of the coupling column rotate relative to the plurality of first cutters of the accommodating cylinder, thus trimming the nose hairs.

Further objective of the present invention is to provide nose hair trimmer in which the accommodating cylinder is removed from the fitting sleeve and the coupling column easily to eliminate cut nose hairs, thereafter the accommodating cylinder is connected with the fitting sleeve quickly.

Another objective of the present invention is to provide nose hair trimmer in which an electric driving apparatus is electrically connected with the coupling column to drive the coupling column to rotate quickly, thus cutting the nose hairs quickly.

### BRIEF DESCRIPTION OF THE DRAWINGS

FIG. 1 is a perspective view showing the exploded components of a nose hair trimmer according to a first embodiment of the present invention.

FIG. 2 is a perspective view showing the assembly of the nose hair trimmer according to the first embodiment of the present invention.

FIG. 3 is a bottom plane view showing the assembly of the nose hair trimmer according to the first embodiment of the present invention.

FIG. 4 is a top plane view showing the assembly of the nose hair trimmer according to the first embodiment of the present invention

FIG. 5 is a cross sectional view showing the exploded components of a nose hair trimmer according to a second embodiment of the present invention.

FIG. 6 is a side plane view showing the assembly of the nose hair trimmer according to the second embodiment of the present invention.

### DETAILED DESCRIPTION OF THE PREFERRED EMBODIMENTS

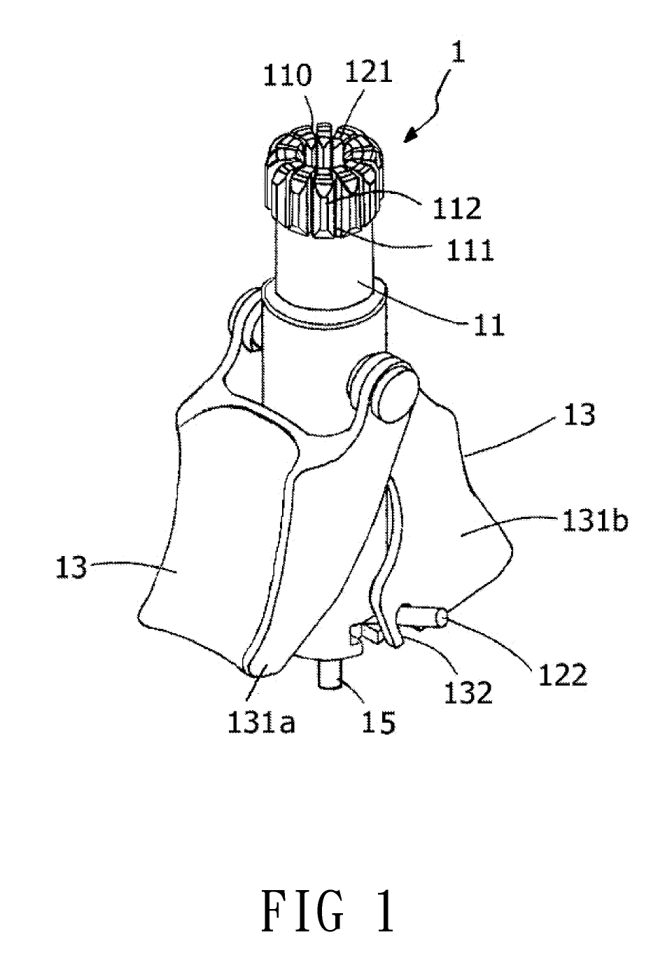

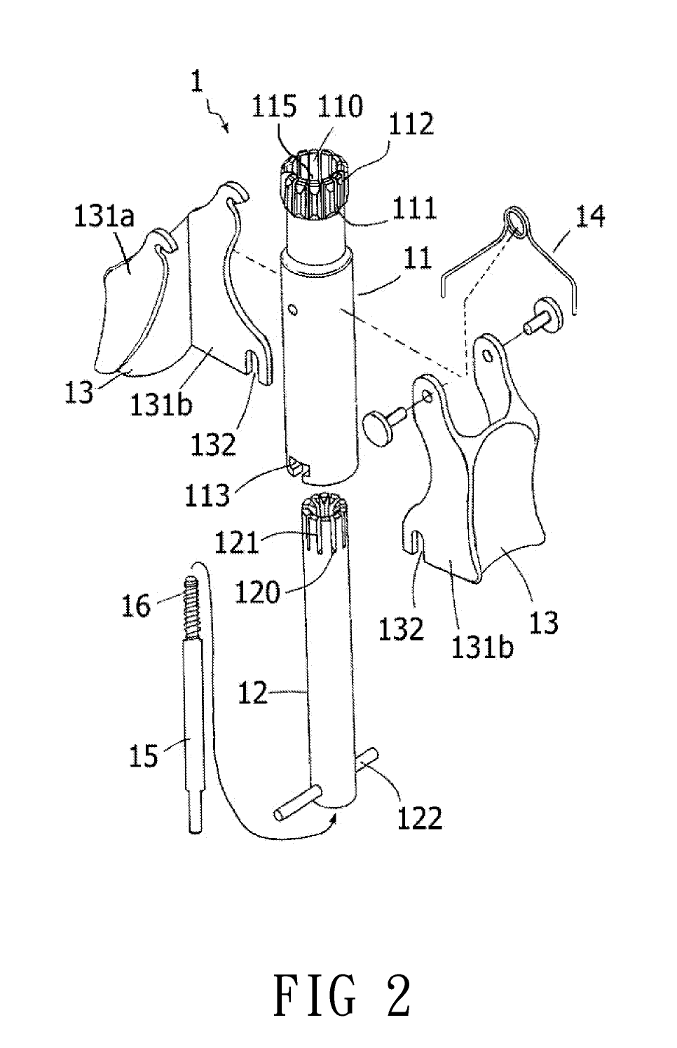

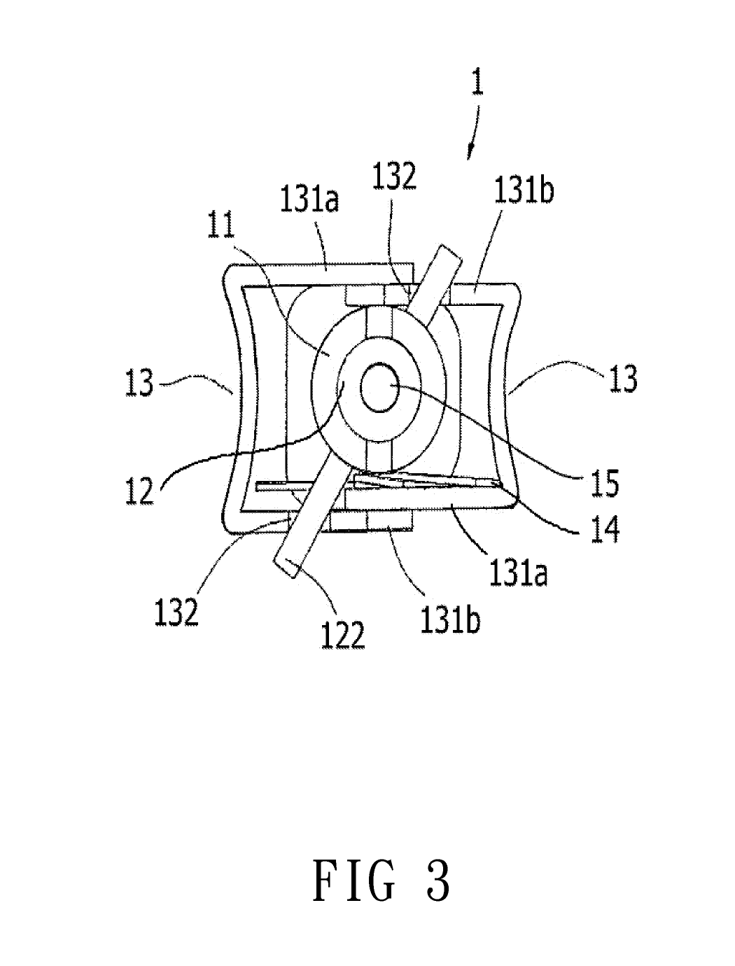

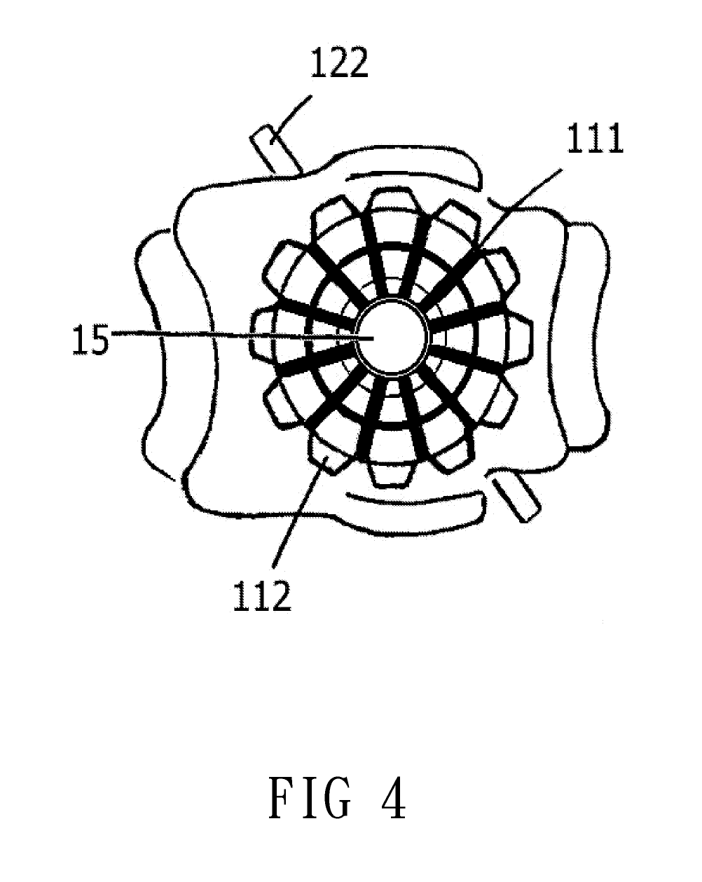

With reference to FIGS. 1 to 4, a nose hair trimmer 1 according to a first embodiment of the present invention comprises: an accommodating cylinder 11 and a coupling column 12, wherein the accommodating cylinder 11 includes a plurality of first cutters 110 arranged around a top end thereof, and between any two adjacent first cutters 110 is defined a first slot 111, each first cutter 110 has a tooth portion 112 formed thereon, and the tooth portion 112 is a flat face on which patterns (such as concave patterns, convex patterns or a combination of the concave and convex patterns) formed to retain nose hairs. The accommodating cylinder 11 is hollow and also includes a through hole 115 defined therein so as to accommodate the coupling column 12, such that the accommodating cylinder 11 is coaxial to the coupling column 12, and plural second cutters 121 on a top of the coupling column 12 correspond to the plurality of first cutters 110 of the accommodating cylinder 11, the coupling column 12 is rotatable in and relative to the accommodating cylinder 11. Furthermore, between any two second cutters 121 is defined a second slot 120. The coupling column 12 is a hollow tube and includes a press stem 15 accommodated therein, wherein the press stem 15 has a returning spring 16 fitted thereon, such that when the press stem 15 is pressed toward the plural second cutters 121, the nose hairs among the plurality of first cutters 121, the plural second slots 120, and the plurality of first slots 111 are cut. In addition, two opposite pressing members 13 are rotatably connected with the accommodating cylinder 11, and a torsion spring 14 is defined between the two pressing members 13, wherein each pressing member 13 has a first extending piece 131a and a second extending piece 132b which are arranged on two sides of the each pressing member 13, and the first extending piece 131a corresponds to the second extending piece 131b, the second extending piece 131b has a notch 132 formed on a bottom thereof so as to accommodate a positioning bolt 122 which extends outwardly from two sides of a bottom end of the coupling column 12, and the accommodating cylinder 11 further includes two T-shaped recesses 113 defined on two sides of a bottom thereof, wherein each T-shaped recess 113 contacts with the positioning bolt 122.

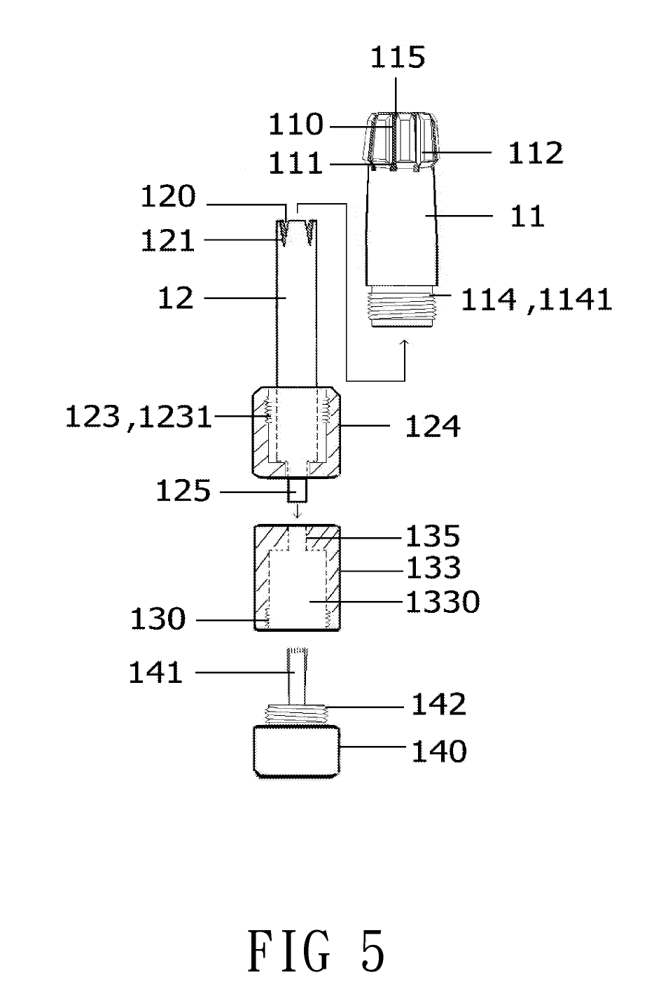

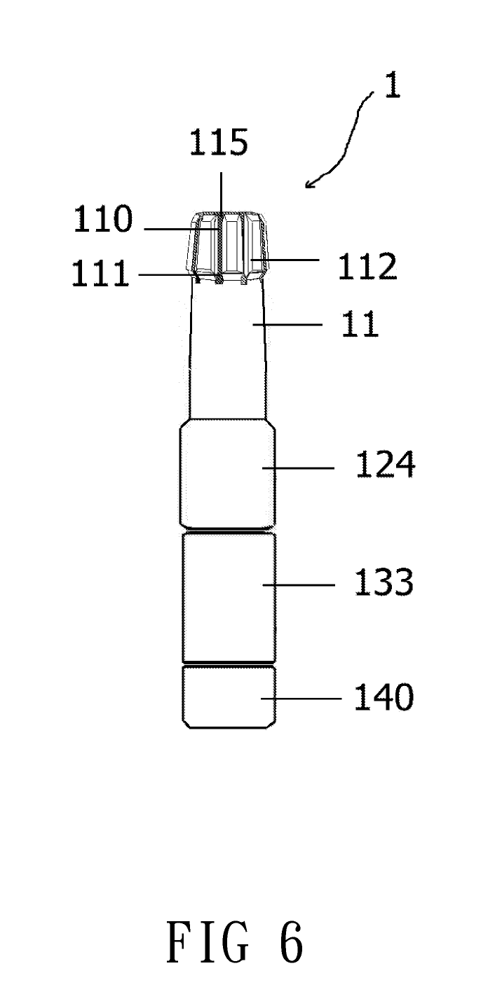

Referring further to FIGS. 5 and 6, a nose hair trimmer 1 according to a second embodiment of the present invention comprises: an accommodating cylinder 11 and a coupling column 12, wherein the accommodating cylinder 11 includes a plurality of first cutters 110 arranged around a top end thereof, and between any two adjacent first cutters 110 is defined a first slot 111, each first cutter 110 has a tooth portion 112 formed thereon. The accommodating cylinder 11 is hollow and includes a through hole 115 defined therein, wherein the accommodating cylinder 11 further includes a first fixing portion 114 extending outwardly from a bottom end thereof, and the first fixing portion 114 has outer threads 1141 formed thereon. The coupling column 12 is inserted into a fitting sleeve 124 and has a locking post 125 extending outwardly from a bottom thereof and extending out of the fitting sleeve 124, the locking post 125 also inserts into the coupling column 12 of the fitting sleeve 124, such that the locking post 125 rotates relative to the fitting sleeve 124. The fitting sleeve 124 includes a second fixing portion 123 fixed therein, and the second fixing portion 123 has inner threads 1231 formed thereon, such that when the coupling column 12 inserts into the through hole 115 of the accommodating cylinder 11, the outer threads 1141 of the first fixing portion 114 of the accommodating cylinder 11 screw with the inner threads 1231 of the second fixing portion 123 of the fitting sleeve 124, hence the coupling column 12 inserts into the through hole 115 of the accommodating cylinder 11, and the first fixing portion 114 of the accommodating cylinder 11 is locked in the fitting sleeve 124. Preferably, the coupling column 12 is coaxial to the accommodating cylinder 11, and plural second cutters 121 on a top of the coupling column 12 correspond to the plurality of first cutters 110 on the top of the accommodating cylinder 11, the coupling column 12 rotates with respect to the accommodating cylinder 11. Furthermore, between any two second cutters 121 is defined a second slot 120. The nose hairs trimmer 1 further comprises a base 133, and the base 133 includes a storage groove 135 defined in an upper end thereof so as to accommodate the locking post 125 of the coupling column 12 of the fitting sleeve 124, such that a bottom of the fitting sleeve 124 is in connection with the upper end of the base 133. The base 133 has a receiving chamber 1330 defined therein below the storage groove 135, and a diameter of the fitting sleeve 124 is equal to that of the base 133.

The nose hair trimmer 1 further comprises a brush seat 140 formed in any one of a square, polygon, and geometry shapes, and the brush seat 140 has patterns or characters formed thereon. The brush seat 140 has a threaded protrusion 142 extending outwardly around an upper end thereof, and the threads protrusion 142 has plural bristles 141 extending upwardly from a top thereof, wherein the threaded protrusion 142 of the brush seat 140 corresponds to a screwing portion 130 in a bottom of the base 133, such that the brush seat 140 is locked with the bottom of the base 133, and the plural bristles 141 of the brush seat 140 is accommodated in the receiving chamber 1330 of the base 133 easily.

In operation, the fitting sleeve 124 is grasped by one hand, and the base 133 is rotated by the other hand to drive a rotation of the coupling column 12 with respect to the accommodating cylinder 11, such that the plural second cutters 121 of the coupling column 12 rotate relative to the plurality of first cutters 110 of the accommodating cylinder 11, thus trimming the nose hairs. Preferably, the accommodating cylinder 11 is removed from the fitting sleeve 124 and the coupling column 12 easily to eliminate cut nose hairs. Thereafter, the accommodating cylinder 11 is connected with the fitting sleeve 124 quickly.

Preferably, an electric driving apparatus is electrically connected with the coupling column 12 to drive the coupling column 12 to rotate quickly, thus cutting the nose hairs quickly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A nose hair trimmer comprising: an accommodating cylinder and a coupling column, wherein the coupling column is inserted into a through hole of the accommodating cylinder, such that the coupling column is coaxial to the accommodating cylinder, and a plurality of first cutters on a top of the accommodating cylinder correspond to plural second cutters on a top of the coupling column, wherein between any two adjacent first cutters is defined a first slot, and between any two second cutters is defined a second slot, such that the coupling column rotates relative to the accommodating cylinder;
wherein each first cutter of the accommodating cylinder has a tooth portion formed thereon.

2. The nose hair trimmer as claimed in claim 1, wherein two opposite pressing members are rotatably connected with the accommodating cylinder, and a torsion spring is defined between the two pressing members, wherein each pressing member has a first extending piece and a second extending piece which are arranged on two sides of the each pressing member, and the first extending piece corresponds to the second extending piece, the second extending piece has a notch formed on a bottom thereof so as to accommodate a positioning bolt which extends outwardly from two sides of a bottom end of the coupling column, and the accommodating cylinder further includes two T-shaped recesses defined on two sides of a bottom thereof, wherein each T-shaped recess contacts with the positioning bolt; the coupling column is a hollow tube and includes a press stem accommodated therein, and the press stem has a returning spring fitted thereon.

3. A nose hair trimmer comprising: an accommodating cylinder and a coupling column, wherein the coupling column is inserted into a through hole of the accommodating cylinder, such that the coupling column is coaxial to the accommodating cylinder, and a plurality of first cutters on a top of the accommodating cylinder correspond to plural second cutters on a top of the coupling column, wherein between any two adjacent first cutters is defined a first slot, and between any two second cutters is defined a second slot, such that the coupling column rotates relative to the accommodating cylinder;
wherein each first cutter of the accommodating cylinder has a tooth portion formed thereon;
wherein the accommodating cylinder further includes a first fixing portion extending outwardly from a bottom end thereof, the coupling column is inserted into a fitting sleeve and has a locking post extending outwardly from a bottom thereof and extending out of the fitting sleeve, the locking post also inserts into the coupling column of the fitting sleeve, such that the locking post rotates relative to the fitting sleeve;
wherein the fitting sleeve includes a second fixing portion fixed therein to correspond to the first fixing portion of the accommodating cylinder;
wherein the nose hair trimmer further comprises: a base, and the base includes a storage groove defined in an upper end thereof so as to accommodate the locking post of the coupling column of the fitting sleeve, such that a bottom of the fitting sleeve is in connection with the upper end of the base.

4. The nose hair trimmer as claimed in claim 1, wherein an electric driving apparatus is electrically connected with the coupling column to drive the coupling column to rotate.

5. The nose hair trimmer as claimed in claim 3, wherein an electric driving apparatus is electrically connected with the coupling column to drive the coupling column to rotate.

6. The nose hair trimmer as claimed in claim 1, wherein the tooth portion is a flat face.

7. The nose hair trimmer as claimed in claim 3, wherein the tooth portion is a flat face.

8. The nose hair trimmer as claimed in claim 6, wherein the flat face has patterns formed thereon, and the patterns are selected from concave patterns, convex patterns, and a combination of the concave and convex patterns.

9. The nose hair trimmer as claimed in claim 7, wherein the flat face has patterns formed thereon, and the patterns are selected from concave patterns, convex patterns, and a combination of the concave and convex patterns.

10. The nose hair trimmer as claimed in claim 3, the fitting sleeve is grasped by one hand, and the base is rotated by the other hand to drive a rotation of the coupling column with respect to the accommodating cylinder, such that the plural second cutters of the coupling column rotate relative to the plurality of first cutters of the accommodating cylinder, thus trimming nose hairs.

11. The nose hair trimmer as claimed in claim 3, wherein the first fixing portion of the accommodating cylinder has outer threads formed thereon, and the second fixing portion has inner threads formed thereon, such that the outer threads of the first fixing portion of the accommodating cylinder screw with the inner threads of the second fixing portion of the fitting sleeve, and the first fixing portion of the accommodating cylinder is locked in the fitting sleeve.

12. The nose hair trimmer as claimed in claim 3, wherein the nose hair trimmer further comprises a brush seat, and the brush seat has a threaded protrusion extending outwardly around an upper end thereof, and the threads protrusion has plural bristles extending upwardly from a top thereof, wherein the threaded protrusion of the brush seat corresponds to a screwing portion in a bottom of the base, the base has a receiving chamber defined therein below the storage groove, such that the brush seat is locked with the bottom of the base, and the plural bristles of the brush seat is accommodated in the receiving chamber of the base.

13. The nose hair trimmer as claimed in claim 3, wherein the brush seat is formed in any one of a square, polygon, and geometry shapes.
